(19) United States
(12) Patent Application Publication
(10) Pub. No.: US 2022/0013762 A1
(43) Pub. Date: Jan. 13, 2022

(54) LITHIUM POSITIVE ELECTRODE ACTIVE MATERIAL

(71) Applicant: HALDOR TOPSØE A/S, Kgs. Lyngby (DK)

(72) Inventors: Jonathan HØJBERG, Bagsværd (DK); Jakob Weiland HØJ, Gentofte (DK); Christian Fink ELKJÆR, Birkerød (DK); Lars Fahl LUNDEGAARD, Roskilde (DK); Søren DAHL, Hillerød (DK)

(73) Assignee: HALDOR TOPSØE A/S, Kgs. Lyngby (DK)

(21) Appl. No.: 17/289,313

(22) PCT Filed: Dec. 18, 2019
(86) PCT No.: PCT/EP2019/086034

§ 371 Date: Apr. 28, 2021

(30) Foreign Application Priority Data
Dec. 19, 2018 (DK) PA 2018 01029

(51) Int. Cl. H01M 4/131; H01M 4/485; C01G 45/12; C01G 53/00

(52) U.S. Cl. CPC H01M 4/131; H01M 4/485; H01M 2004/028; C01G 53/54; C01G 45/1242

(57) ABSTRACT

The invention relates to a lithium positive electrode active material for a high voltage secondary battery: the lithium positive electrode active material comprising at least 94 wt % spinel, where the spinel has a net chemical composition of LiₓNi_{y}Mn_{2-y}O₄, wherein:

0.95≤x≤1.05;

0.43≤y≤0.47.

The lithium positive electrode active material is made up of particles characterized by one or more of the following parameter ranges: the particles have average aspect ratio below 1.6, the particles have a roughness below 1.35, particles have a circularity above 0.55. Then invention also relates to a process for the preparation of the lithium positive electrode active material as well as a secondary battery comprising the lithium positive electrode active material.

### FIELD OF THE INVENTION

The present invention relates to a lithium positive electrode active material for use in high voltage lithium secondary batteries. In particular, the present invention relates to such a material with a high capacity, high voltage against Li/Li⁺ reference and low degradation. Moreover, the present invention relates to a process for the preparation of such a material.

### BACKGROUND

Lithium positive electrode active materials may be characterised by the formula: LiₓNi_{y}Mn_{2-y}O_{4-δ} wherein 0.9≤x≤1.1, 0.4≤y≤0.5 and 0≤δ≤0.1. Such materials may be used for e.g.: portable equipment (U.S. Pat. No. 8,404,381 B2); electric vehicles, energy storage systems, auxiliary power units and uninterruptible power supplies. Lithium positive electrode active materials are seen as a prospective successor to current lithium secondary battery cathode materials such as: LiCoO₂, and LiMn₂O₄.

Lithium positive electrode active materials may be prepared from one or more precursor obtained by a co-precipitation process. The precursor(s) and product are spherical due to the co-precipitation process. Electrochimica Acta (2014), pp 290-296 discloses a material prepared from precursors obtained by a co-precipitation process followed by sequential sintering (heat treatment) at 500° C., followed by 800° C. The product obtained is highly crystalline and has a spinel structure after the first heat treatment step (500° C.). A uniform morphology, tap density of 2.03 g cm⁻³ and uniform secondary particle size of 5.6 μm of the product is observed. Electrochimica Acta (2004) pp 939-948 states that a uniform distribution of spherical particles exhibits a higher tap density than irregular particles due to their greater fluidity and ease of packing. It is postulated that the hierarchical morphology obtained and large secondary particle size of the LiNi_{0.5}Mn_{1.5}O₄ increases the tap density.

Lithium positive electrode active materials may also be prepared from precursors obtained by mechanically mixing starting materials to form a homogenous mixture, as disclosed in U.S. Pat. No. 8,404,381 B2 and U.S. Pat. No. 7,754,384 B2. The precursor is heated at 600° C., annealed between 700 and 950° C., and cooled in a medium containing oxygen. It is disclosed that the 600° C. heat treatment step is required in order to ensure that the lithium is well incorporated into the mixed nickel and manganese oxide precursor. It is also disclosed that the annealing step is generally at a temperature greater than 800° C. in order to cause a loss of oxygen while creating the desired spinel morphology. It is further disclosed that subsequent cooling in an oxygen containing medium enables a partial return of oxygen. U.S. Pat. No. 7,754,384 B2 is silent with regard to the tap density of the material. It is disclosed that 1 to 5 mole percent excess of lithium is used to prepare the precursor.

J. Electrochem. Soc. (1997) 144, pp 205-213, also discloses the preparation of spinel LiNi_{0.5}Mn_{1.5}O₄ from a precursor prepared from mechanically mixing starting materials to obtain a homogenous mixture. The precursor is heated three times in air at 750° C. and once at 800° C. It is disclosed that LiNi_{0.5}Mn_{1.5}O₄ loses oxygen and disproportionates when heated above 650° C.; however, the LiNi_{0.5}Mn_{1.5}O₄ stoichiometry is regained by slow cooling rates in an oxygen containing atmosphere. Particle sizes and tap densities are not disclosed. It is also disclosed that the preparation of spinel phase material by mechanically mixing starting materials to obtain a homogenous mixture is difficult, and a precursor prepared by a sol-gel method was preferred.

It is desirable to provide a lithium positive electrode active material with a high phase purity and with a high capacity. It is also desirable to provide a high stability lithium positive electrode active material, wherein the capacity of the lithium positive electrode active material decreases by no more than 4% over 100 cycles between from 3.5 to 5.0 V at 55° C., and up to 2% over 100 cycles between from 3.5 to 5.0 V at room temperature. It is furthermore desirable to provide a lithium positive electrode active material with a high tap density as a high tap density may increase the energy density of the battery. Finally, it is desirable to provide a lithium positive electrode active material with an optimum Ni-content in order to balance of the energy density and degradation of the lithium positive electrode active material.

### SUMMARY

The invention relates to a lithium positive electrode active material for a high voltage secondary battery, said lithium positive electrode active material comprising at least 94 wt % spinel, said spinel having a net chemical composition of LiₓNi_{y}Mn_{2-y}O₄, wherein:

0.95≤x≤1.05;

0.43≤y≤0.47; and

wherein said lithium positive electrode active material is made up of particles, said particles being characterized by one or more of the following parameter ranges: the particles have average aspect ratio below 1.6, the particles have a roughness below 1.35, particles have a circularity above 0.55.

The inventors have realized that a particularly high capacity and low fade can be obtained when the content of Ni in the lithium positive electrode active material lies in a relatively narrow range, viz. when 0.43≤y≤0.47, when the lithium positive electrode active material comprises at least 94 wt % of the spinel, namely maximum 6 wt % impurities or non-spinel phases, such as rock salt and when the lithium positive electrode active material is made up of particles which are substantial spherical.

In particular, the present invention is based on the experimental finding that when the particles making up the lithium positive electrode active material are substantial spherical, a very low degradation rate of the lithium positive electrode active material is obtainable, as well as a high energy density and easy powder handling in subsequent processing steps. The present invention has further provided a number of specific parameters for experimentally measuring how spherical a particle is and shown that there exist a clear correlation between each of the said parameters and the level of degradation.

The range of y values is chosen to provide a lithium positive electrode active material with good performance whilst balancing low degradation as well as high energy density. If y is larger than 0.47, the lithium positive electrode active material will experience increased degradation, whilst if y is smaller than 0.43, the Mn content of the lithium positive electrode active material will increase with a resultant decrease of the energy density of a battery using the lithium positive active electrode material. Thus, the range 0.43≤y≤0.47 has been found to provide an optimum Ni-content in the balancing of a high energy density and low degradation. Preferably, y is about 0.45.

When the particles of the lithium positive electrode active material are characterized by an average aspect ratio below 1.6 and/or a roughness below 1.35, the particles are substantially spherical.

Particle shape can be characterized using aspect ratio, defined as the ratio of particle length to particle breadth, where length is the maximum distance between two points on the perimeter and breadth is the maximum distance between two perimeter points linked by a line perpendicular to length.

The advantage of a lithium positive electrode active material with an aspect ratio below 1.6 and/or a roughness below 1.35 is the stability of the lithium positive electrode active material due to the low surface area thereof. Preferably, the average aspect ratio is below 1.5 and more preferably even below 1.4. Moreover, such aspect ratio and roughness provides for a material with high tap density. Values for aspect ratio and roughness may be determined from scanning electron micrographs of particles embedded in epoxy and polished to reveal the particle cross sections as described in example B.

Particle shape can further be characterized using circularity or sphericity and shape of particles. Almeida-Prieto et al. in J. Pharmaceutical Sci., 93 (2004) 621, lists a number of form factors that have been proposed in the literature for the evaluation of sphericity: Heywood factors, aspect ratio, roughness, pellips, rectang, modelx, elongation, circularity, roundness, and the Vp and Vr factors proposed in the paper. Circularity of a particle is defined as 4·π·(Area)/(Perimeter)², where the area is the projected area of the particle. An ideal spherical particle will thus have a circularity of 1, while particles with other shapes will have circularity values between 0 and 1

In an embodiment, the lithium positive electrode active material is made up of particles, where the particles are characterized by a circularity above 0.55. Again, this corresponds to substantially spherical particles.

It should be noted that the content of Ni in the spinel of the lithium positive electrode active material might differ from the content of Ni in the total lithium positive electrode active material, since some Ni may be in the form of impurities, such as rock salt. Such a difference depends e.g. upon the calcination carried out in the preparation of the lithium positive electrode active material and thus the amount of impurities or non-spinel phases in the lithium positive electrode active material. In order to obtain a correct y value for the spinel, it is important to use a method suitable for this purpose, and this is true for the following three methods: Scanning electron microscopy (SEM), x-ray diffraction measurement and scanning transmission electron microscopy (STEM) in combination with energy dispersive x-ray spectroscopy (EDS). The methods to measure content of Ni in the total lithium positive electrode active material and in the spinel of the lithium positive electrode active material, respectively, are described in more detail in Example C. It should also be noted that the determination of the capacity is as described in Example A.

“Spinel” means a crystal lattice where oxygen is arranged in a slightly distorted cubic close-packed lattice and cations occupying interstitial octahedral and tetrahedral sites in the lattice. Oxygen and the octahedrally coordinated cations form a framework structure with a 3 dimensional channel system which occupy the tetrahedrally coordinated cations. The ratio between tetrahedrally coordinated and octahedrally coordinated cations is approximately 1:2, and the cation to oxygen ratio is approximately 3:4 for spinel type structures. Cations in the octahedral site can consist of a single element or a mixture of different elements. If a mixture of different types of octahedrally coordinated cations by themselves form a three dimensional periodic lattice, then the spinel is called an ordered spinel. If the cations are more randomly distributed, then the spinel is called a disordered spinel. Examples of an ordered and a disordered spinel, as described in the P4332 and Fd-3m space groups respectively, are described in Adv. Mater. (2012) 24, pp 2109-2116.

“Rock salt” means a crystal lattice where oxygen is arranged in a slightly distorted cubic close-packed lattice and the cations are fully occupying the octahedral sites in the lattice. The cations can consist of a single element or a mixture of different elements. A mixture of different types of cations can be statistically disordered, maintaining the cubic symmetry (Fm-3m), or ordered resulting in a lower symmetry. The cation to oxygen ratio is 1:1 for rock salt type structures.

The phase composition of a lithium positive electrode active material may be determined based on X-ray diffraction patterns acquired using a Phillips PW1800 instrument system in θ-2θ geometry working in Bragg-Brentano mode using Cu Kα radiation (λ=1.541 Å). The observed data needs to be corrected for experimental parameters contributing to shifts in the observed data. This is achieved using the full profile fundamental parameter approach as implemented in the TOPAS software from Bruker. The phase composition as determined from Rietveld analysis is given in wt % with a typical uncertainty of 1-2 percentage points and represents the relative composition of all crystalline phases. Any amorphous phases are thus not included in the phase composition.

Discharge capacities and discharge currents in this document are stated as specific values based on the mass of the lithium positive electrode active material.

It should be noted, that the lithium positive electrode active material may comprise small amounts of other elements than Li, Ni, Mn and O. Such elements may for example be one or more of the following: B, N, F, Mg, Al, Si, P, S, Ca, Ti, Cr, Fe, Co, Cu, Zn, Zr, Mo, Sn, W. Such small amounts of such elements may originate from impurities in starting materials for preparing the lithium positive electrode active material or may be added as dopants with the purpose to improve some properties of the lithium positive electrode active material.

The value of x is related to the Li content of the pristine lithium positive electrode active material, viz. the lithium positive electrode active material as synthesized. When the lithium positive electrode active material is incorporated in a battery, the x value typically changes compared to the x value within the pristine lithium positive electrode active material. A change in the x value will also change the value of the lattice parameter a. The benefits described herein are based on the pristine lithium positive electrode active material, i.e. the x value in the pristine lithium positive electrode active material.

If a lithium positive electrode active material is extracted from a battery, the x value of the pristine material, viz. before the lithium positive electrode active material was incorporated as a part of the battery, can be determined by discharging the extracted lithium positive electrode active material to a potential of 3.5 V vs. Li/Li⁺ at a current below 29 mA/g and keeping the potential of 3.5 V vs. Li/Li⁺ for 5 hours in a half-cell with a lithium metal anode as described in Example A.

In an embodiment, at least 90 wt % of the spinel of the lithium positive electrode active material is crystallized in disordered space group Fd-3m. It has been observed that a disordered material provides for a lower degradation compared to a material having similar stoichiometry but prepared as ordered material. Ordering is usually characterized by techniques such as Raman spectroscopy, X-ray diffraction and Fourier transform infrared spectroscopy as described in Ionics (2006) 12, pp 117-126. As described further in Example D, quantitative ordering parameters can be extracted either based on Raman spectroscopy or electrochemically as a measurement of the separation between the two Ni-plateaus at around 4.7 V. This is exemplified in FIG. 6b. As shown in FIG. 3, the two parameters correlate very well. FIG. 4 shows comparison between the plateau separation dV and degradation of the lithium positive electrode active material. It is seen that ordering is not the only parameter affecting the degradation, but it is seen that a minimum degradation exists at a given plateau separation, and thus at a given degree of ordering. If the spinel is too ordered, it is not possible to achieve low degradation rates. A significant increase in degradation is observed when the plateau separation is below 40 mV. Preferably, the plateau separation should be at least 50 mV and preferably around 60 mV.

In an embodiment, the lithium positive electrode active material in a half-cell has a difference of at least 50 mV between the potentials at 25% and 75% of the capacity above 4.3 V during discharge with a discharge current of around 29 mA/g. The difference between the potentials at 25% and 75% of the capacity above 4.3 V during discharge is typically maximum 75 to 80 mV. The difference between the potentials at 25% and 75% of the capacity above 4.3 V during discharge is also denoted “plateau separation” and dV, and is a measure of the free energies related to insertion and removal of lithium at a given state of charge and this is influenced by whether the spinel phase is disordered or ordered. Without being bound by theory, a plateau separation of at least 50 mV seems advantageous since this is related to whether the lithium positive electrode active material is in an ordered or a disordered phase and to the fade rate of a half cell with the lithium positive electrode active material. The plateau separation is preferably about 60 mV.

In an embodiment, the lithium positive electrode active material is calcined so that the lattice parameter a is between 8.171 Å and 8.183 Å. These values of the lattice parameter a are related to a lithium positive electrode active material with a low degradation.

In particular, the lithium positive electrode active material has a lattice parameter a, where the lattice parameter a lies between the values (−0.1932y+8.2613) Å and 8.183 Å. Preferably, the lattice parameter a lies between the values (−0.1932y+8.2613) Å and (−0.1932y+8.2667) Å. More preferably, the lattice parameter a lies between the values (−0.1932y+8.2613) Å and (−0.1932y+8.2641) Å. These values of the lattice parameter a are related to a lithium positive electrode active material with a low degradation and high energy density. In an embodiment, the parameter a lies between the values (−0.1932y+8.2613) Å and 8.183 Å and 0.43≤y<0.45. Preferably, the parameter a lies between the values (−0.1932y+8.2613) Å and (−0.1932y+8.2667) Å and 0.43≤y<0.45. These combinations of the lattice parameter a and the value of y corresponds to a lithium positive electrode active material with a particularly low degradation.

In an embodiment, the lithium positive electrode active material has a tap density equal to or greater than 2.2 g/cm³. Preferably, the tap density of the lithium positive electrode active material is equal to or greater than 2.25 g/cm³; equal to or greater than 2.3 g/cm³, such as for example 2.5 g/cm³.

“Tap density” is the term used to describe the bulk density of a powder (or granular solid) after consolidation/compression prescribed in terms of ‘tapping’ the container of powder a measured number of times, usually from a predetermined height. The method of ‘tapping’ is best described as ‘lifting and dropping’. Tapping in this context is not to be confused with tamping, sideways hitting or vibration. The method of measurement may affect the tap density value and therefore the same method should be used when comparing tap densities of different materials. The tap densities of the present invention are measured by weighing a measuring cylinder with inner diameter of 10 mm before and after addition of around 5 g of powder to note the mass of added material, then tapping the cylinder on the table for some time and then reading of the volume of the tapped material. Typically, the tapping should continue until further tapping would not provide any further change in volume. As an example only, the tapping may be about 120 or 180 times, carried out during a minute.

One way to quantify the size of particles in a slurry or a powder is to measure the size of a large number of particles and calculate the characteristic particle size as a weighted mean of all measurements. Another way to characterize the size of particles is to plot the entire particle size distribution, i.e. the volume fraction of particles with a certain size as a function of the particle size. In such a distribution, D10 is defined as the particle size where 10% of the volume fraction of the population lies below the value of D10, D50 is de-fined as the particle size where 50% of the volume fraction of the population lies below the value of D50 (i.e. the median), and D90 is defined as the particle size where 90% of the volume fraction of the population lies below the value of D90. Commonly used methods for determining particle size distributions include laser diffraction measurements and scanning electron microscopy measurements, coupled with image analysis.

The lithium positive electrode active material is a powder composed of or made up of particles. Such particles are e.g. formed by a dense agglomerate of primary particles; in this case they may be specified as “secondary particles”. Alternatively, the particles may be single crystals. Such single crystal particles are typically rather small, with a D50 of 5 μm or below. Thus, the term “particles” is meant to cover both primary particles, such as single crystals, as well as secondary particles.

In an embodiment, D50 of the particles making up the lithium positive electrode active material satisfies: 3 μm<D50<12 μm. Preferably, 5 μm<D50<10 μm, such as about 7 μm. It is an advantage when D50 is between 3 and 12 μm in that such particle sizes enable easy powder handling and low surface area, while maintaining sufficient surface to transport lithium and electrons in and out of the structure during discharge and charge. In an embodiment, the distribution of the size of the particles is characterized in that the ratio between D90 and D10 is smaller than or equal to 4. This corresponds to a narrow size distribution. Such a narrow size distribution, in combination with D50 of the particles being between 3 and 12 μm, indicates that the lithium positive electrode material has a low number of fines, viz. a low number of particles with a particle size less than 1 μm, and thus a low surface area. In addition, a narrow particle size distribution ensures that the electrochemical response of all the particles of the lithium positive electrode material will be essentially the same so that stressing a fraction of the particles significantly more during charge and discharge than the rest is avoided.

The particle size distribution values D10, D50 and D90 are defined and measured as described in Jillavenkatesa A, Dapkunas S J, Lin-Sien Lum: Particle Size Characterization, NIST (National Institute of Standards and Technology) Special Publication 960-1, 2001. Commonly used methods for determining particle size distributions include laser diffraction measurements and scanning electron microscopy measurements, coupled with image analysis.

In an embodiment, the lithium positive electrode active material has a BET area below 1.5 m²/g. The BET surface may be below 1.0 m²/g or 0.5 m²/g and even down to about 0.3 or 0.2 m²/g. It is advantageous that the BET surface area is this low, since a low BET surface area correspond to a dense material with a low porosity. Since degradation reactions occur on the surface of the lithium positive electrode active material, such a material typically is a stable material, viz. a material with low degradation rate.

In an embodiment, the lithium positive electrode active material is made up of particles, where the particles are characterized by a solidity above 0.8. In an embodiment, the lithium positive electrode active material is made up of particles, where the particles are characterized by a porosity below 3%. These ranges of parameters are related to a lithium positive electrode active material with a low degradation. Values for circularity, solidity and porosity may be determined from scanning electron micrographs of particles embedded in epoxy and polished to reveal the particle cross sections as described in example B.

In an embodiment 0.99≤x≤1.01 in the formula LiₓNi_{y}Mn_{2-y}O₄. This is preferable since the crystal structure of the lithium positive electrode active material is utilized well when there is about 1 lithium ion per two transition metal ions per four oxygen atoms in the crystal of the spinel. Again, the value of x is related to the Li content of the pristine lithium positive electrode active material, viz. the lithium positive electrode active material as synthesized. When the lithium positive electrode active material is in a battery, the x value typically changes compared to the x value within the pristine lithium positive electrode active material. A change in the x value will also change the value of the lattice parameter a. The benefits described herein is based on the pristine lithium positive electrode active material, i.e. the x value in the pristine lithium positive electrode active material.

If a lithium positive electrode active material is extracted from a battery, the x value of the pristine material, viz. before the lithium positive electrode active material was incorporated as a part of the battery, can be determined by discharging the extracted lithium positive electrode active material to a potential of 3.5 V vs. Li/Li⁺ at a current below 29 mA/g and keeping the potential of 3.5 V vs. Li/Li⁺ for 5 hours in a half-cell with a lithium metal anode as described in Example A.

In an embodiment, the specific capacity of the lithium positive electrode active material in a half cell decreases by no more than 8% over 100 cycles between 3.5 to 5.0 V at 55° C. Preferably, the specific capacity of the lithium positive electrode active material decreases by no more than 6% over 100 charge-discharge cycles between from 3.5 to 5.0 V; and more preferably decreases by no more than 4% over 100 charge-discharge cycles between from 3.5 to 5.0 V when cycled at 55° C. with charge and discharge currents of 74 mA/g and 147 mA/g, respectively. Cell types and testing parameters are provided in Example A.

In an embodiment, the lithium positive electrode active material is synthesized from a precursor containing Li, Ni, and Mn in a ratio Li:Ni:Mn: X:Y:2-Y, wherein: 0.95≤X≤1.05; and 0.42≤Y<0.5. As used herein, the content of Li, Ni and Mn in the spinel of the lithium positive electrode active material, viz. in the net chemical composition, LiₓNi_{y}Mn_{2-y}O₄, is indicated by the letters x and y, respectively, in lower case. In contrast, the contents of Li and Ni in the precursor used for synthesizing the lithium positive electrode active material are indicated by the letters X and Y, in upper case. If x and y are much different from X and Y, it implies a low phase purity. To obtain a high phase purity and thus a high capacity, it is thus desired that x is close to or equal to X and that y is close to or equal Y. Furthermore, impurity phases within the lithium positive electrode active material, viz. phases that are not spinel, may contain significant amount of lithium or different amounts of Mn and Ni. This can reduce x and change y significantly within the spinel. Such impurity phases will cause further decrease in capacity and reduced stability of the spinel. The presence of impurities may furthermore increase degradation of the electrolyte, when the lithium positive electrode active material is incorporated in a battery cell, as well as dissolution of Mn and Ni from the lithium positive electrode active material. Both effects are known to increase capacity fade in battery cells.

The contents of Li, Ni and Mn in the precursor(s) used for synthesizing the lithium positive electrode active material as indicated by the letters X and Y can be determined by measuring the amount of Li, Ni and Mn in the lithium positive electrode active material, viz. a sample including both spinel and impurities in amounts representative of the entire sample. Such measurements may be induced coupled plasma or EDS as described in Example C.

In an embodiment, the lithium positive electrode active material has a capacity of at least 138 mAh/g. This corresponds to a lithium positive electrode active material with a capacity close to the theoretical maximum value of 147 mAh/g. When a lithium positive electrode active material has a capacity of at least 138 mAh/g it is thus a phase pure material.

In an embodiment of the invention the y value is determined by means of a method selected from the group consisting of electrochemical determination, X-ray diffraction measurement and scanning transmission electron microscopy (STEM) in combination with energy dispersive X-ray spectroscopy (EDS).

In an embodiment of the lithium positive electrode active material according to the invention, 0.43≤y<0.45.

Another aspect of the invention relates to a process for the preparation of a lithium positive electrode active material according to the invention. The process comprises the steps of:
a. Providing precursors for preparing the lithium positive electrode active material comprising at least 94 wt % spinel having a chemical composition of LiₓNi_{y}Mn_{2-y}O₄ wherein 0.95≤x≤1.05; and 0.43≤y≤0.47;
b. Sintering the precursors of step a by heating the precursors to a temperature of between 500° C. and 1200° C. to provide a sintered product,
c. Cooling the sintered product of step b to room temperature.

As used herein, “precursor” means a composition prepared by mechanically mixing or co-precipitating starting materials to obtain a homogenous mixture (Journal of Power Sources (2013) 238, 245-250); mixing a lithium source with a composition prepared by mechanically mixing starting materials to obtain a homogenous mixture (Journal of Power Sources (2013) 238, 245-250); or mixing a lithium source with a composition prepared by co-precipitation of starting materials (Electrochimica Acta (2014) 115, 290-296). Preferably, step a comprises providing a precursor by co-precipitation of the precursor.

Starting materials are selected from one or more compounds selected from the group consisting of metal oxide, metal carbonate, metal oxalate, metal acetate, metal nitrate, metal sulphate, metal hydroxide and pure metals; wherein the metal is selected from the group consisting of nickel (Ni), manganese (Mn) and lithium (Li) and mixtures thereof. Preferably, the starting materials are selected from one or more compounds selected from the group consisting of manganese oxide, nickel oxide, manganese carbonate, nickel carbonate, manganese sulphate, nickel sulphate, manganese nitrate, nickel nitrate, lithium hydroxide, lithium carbonate and mixtures thereof. Metal oxidation states of starting materials may vary; e.g. MnO, Mn₃O₄, Mn₂O₃, MnO₂, Mn(OH), MnOOH, Ni(OH)₂, NiOOH.

To obtain a good lithium positive electrode active material, it is of course necessary to start out from good starting materials. Preferably, precursors comprise a Ni—Mn precursor that has been co-precipitated, for example as described in WO2018015207 or WO2018015210, as well as a Li precursor. Alternatively, a Ni—Mn precursor could be prepared by mechanically mixing starting material.

In an embodiment of the process of the invention, the precipitated compound is a co-precipitated compound of Ni and Mn formed in a Ni—Mn co-precipitation step. It has been found that in order to obtain a lithium positive electrode active material, wherein the particles have average aspect ratio below 1.6, a roughness below 1.35, and a circularity above 0.55, it is desirable to use a precursor in the form of co-precipitated Ni—Mn.

Preferably, the Mn-containing precursor, which could be a co-precipitated Ni—Mn precursor, is made up of spherical particles with a morphology similar to the lithium positive electrode active material. Thus, a Mn-precursor and/or a Ni—Mn precursor used for the preparation of the lithium positive electrode active material are particles with an aspect ratio below 1.6, a roughness below 1.35, and/or a circularity above 0.55. Preferably, such particles also have a solidity above 0.8.

Ni and Mn may be precipitated with any suitable precipitating anion, such as carbonate. Preferably, said precursor in the form of a co-precipitated Ni—Mn has been prepared in a precipitation step, wherein a first solution of a Ni containing starting material, a second solution of a Mn containing starting material and a third solution of a precipitating anion are added simultaneously to a liquid reaction medium in a reactor in such amounts that in relation to the added Ni, each of Mn and the precipitating anion are added in a ratio of from 1:10 to 10:1, preferably from 1:5 to 5:1, more preferably from 1:3 to 3:1, more preferably from 1:2 to 2:1, more preferably from 1:1.5 to 1.5:1, more preferably from 1:1.2 to 1.2:1 relative to the stoichiometric amounts of the precipitate.

Preferably, the first, second and third solutions are added to the reaction medium in amounts calibrated so as to maintain the pH of the reaction mixture at alkaline pH of e.g. between 8.0 and 10.0, preferably between 8.5 and 10.0. Preferably, said first, second and third solutions are added to the reaction mixture over a prolonged period of e.g. between 2.0 and 11 hours, preferably between 4.0 and 10.0 hours, more preferably, more preferably between 5.0 and 9.0 hours. Preferably, said first, second and third solutions are added to the reaction mixture under vigorous stirring providing an power input of from 2 W/L to 25 W/L, preferably 4 W/L to 20 W/L, more preferably 6 W/L to 15 W/L, and more preferably 8 W/L to 12 W/L.

It has been found that in order to obtain a lithium positive electrode active material, wherein the particles have average aspect ratio below 1.6, a roughness below 1.35, and a circularity above 0.55, it is desirable to use a precursor in the form of co-precipitated Ni—Mn, which has been prepared in a precipitation step carried out as indicated above, i.e. with one or more of the following: Simultaneous addition of the first and second solution over a prolonged period of time under vigorous stirring while controlling the pH as indicated.

The simultaneous addition of said first, second and third solutions has provided a possibility of ensuring that the Ni and Mn on the one side and the precipitating anion on the other side are present in the reaction mixture in the same levels or at least in the same order of magnitude as opposed to a situation where the first and second solutions are added to the third solution. Furthermore, without being bound by theory it is believed that the simultaneous addition of said three solutions means that the precipitated particles will grow in size over the duration of the precipitation process with new layers of precipitated material continuously being deposited on the surface of the growing particle. It is believed that such a gradual building of the particles facilitates the formation of the desired properties of the precursor particles and ultimately the lithium positive electrode active material particles. It is further believed that conducting the precipitation process over a prolonged period of time also contributes to facilitate the said gradual building of the particles.

Furthermore, without being bound by theory it is believed that the vigorous stirring of the reaction mixture also helps the formation of a precursor with the desired properties. In particular, it is believed that the vigorous stirring makes the particles move against each other in a manner so as to result in a grinding effect to make the particles more spherical.

Moreover, it has been found that a precipitation step carried out as indicated above, i.e. with one or more of the following: Simultaneous addition of the first and second solution over a prolonged period of time under vigorous stirring while controlling the pH as indicated, in addition to resulting in more spherical particles also results in particles with enhanced homogeneity in chemical composition.

Finally, it has been found that a precipitation step carried out as indicated above, i.e. with one or more of the following: Simultaneous addition of the first and second solution over a prolonged period of time under vigorous stirring while controlling the pH as indicated, in addition to resulting in more spherical particles also results in precursor particles, which when used to prepare lithium positive electrode active material particles have a reduced level of impurities as described above, i.e. particles containing Li, Ni, and Mn in a ratio Li:Ni:Mn: X:Y:2-Y, wherein: 0.95≤X≤1.05; and 0.42≤Y<0.5, in other words wherein that x is close to or equal to X and that y is close to or equal to Y.

In connection with the present invention, the expression “stoichiometric amounts” means the ratio of the amounts of elements present in a precipitate compound.

In an embodiment, the precursor for the lithium positive electrode active material has been produced from two or more starting materials, where the starting materials are e.g. a nickel-manganese carbonate and a lithium carbonate, or a nickel-manganese carbonate and a lithium hydroxide, or a nickel-manganese hydroxide and a lithium hydroxide, or a nickel-manganese hydroxide and a lithium carbonate, or a manganese oxide and a nickel carbonate and a lithium carbonate.

In an embodiment, part of step b is carried out in a reducing atmosphere. For example, a first part of step b is carried out in a reducing atmosphere, such as N₂, whilst a subsequent part of step b is carried out in air.

In an embodiment, the temperature of step b is between 850° C. and 1100° C.

In an embodiment, during the cooling of step c, the temperature is maintained in an interval between 750° C. and 650° C. for a sufficient amount of time to obtain at least 94% phase purity of the lithium positive electrode active material. The amount of time sufficient to obtain at least 94% phase purity is e.g. as indicated in Examples 1-3 below; however, other combinations of temperature and time are known to the skilled person.

According to another aspect, the invention furthermore relates to a secondary battery comprising a lithium positive electrode active material according to the invention.

According to another aspect the invention further relates to the use of the lithium positive electrode active material according to the invention for reducing the degradation of the material during storage and use.

### SHORT DESCRIPTION OF THE FIGURES

FIG. 1a shows experimental data on the relation between the nickel content in the spinel and the degradation for a range of lithium positive electrode active materials;

FIG. 1b shows experimental data on the relation between the 4V plateau of the lithium positive electrode active material in a half cell and the degradation for a range of lithium positive electrode active materials;

FIG. 1c shows experimental data on the relation between the lattice parameter a in the spinel of the lithium positive electrode active material and the degradation for a range of lithium positive electrode active materials;

FIG. 2a shows experimental data on the relation between the nickel content in the spinel and the lattice parameter a of the spinel for a range of lithium positive electrode active materials;

FIG. 2b shows experimental data on the relation between the 4V plateau of the lithium positive electrode active material in a half cell and the lattice parameter a of the spinel for a range of lithium positive electrode active materials;

FIG. 3 shows experimental data on the relation between cation ordering parameters determined using Raman spectroscopy and electrochemistry, respectively;

FIG. 4 shows experimental data on the relation between degradation and the discharge difference in a half-cell between the potentials at 25% and 75% of the capacity above 4.3 V during discharge with a current of around 29 mA/g for a range of lithium positive electrode active materials;

FIG. 5a shows the relationship between circularity and degradation for four samples of a lithium positive electrode active material according to the invention and with substantially the same spinel stoichiometry;

FIG. 5b shows the relationship between roughness and degradation for four samples of a lithium positive electrode active material according to the invention and with substantially the same spinel stoichiometry;

FIG. 5c shows the relationship between average diameter and degradation for four samples of a lithium positive electrode active material according to the invention and with substantially the same spinel stoichiometry;

FIG. 5d shows the relationship between aspect ratio and degradation for four samples of a lithium positive electrode active material according to the invention and with substantially the same spinel stoichiometry;

FIG. 5e shows the relationship between solidity and degradation for four samples of a lithium positive electrode active material according to the invention and with substantially the same spinel stoichiometry;

FIG. 5f shows the relationship between porosity and degradation for four samples of a lithium positive electrode active material according to the invention and with substantially the same spinel stoichiometry;

FIGS. 6a and 6b show the relationship between capacity and the voltage for a half cell with the lithium positive electrode active material during discharging and charging for determination of 4V plateau and dV, respectively;

FIGS. 7a and 7b are SEM images at different magnifications levels of one of the materials depicted in FIGS. 5a-5f;

FIGS. 8a and 8b are SEM images at different magnifications levels of a second of the materials depicted in FIGS. 5a-5f;

FIGS. 9a and 9b are SEM images at different magnifications levels of a third of the materials depicted in FIGS. 5a-5f;

FIGS. 10a and 10b are SEM images at different magnifications levels of a fourth of the materials depicted in FIGS. 5a-5f;

FIG. 11 shows the Ni content of the spinel, Niy, measured by scanning transmission electron microscopy energy dispersive x-ray spectroscopy (STEM-EDS) compared to values from electro chemistry (EC) for three samples with different Niy;

FIG. 12 shows the heating profile used to obtain the cathode electrode active material described in Example 2;

FIG. 13 shows a Raman spectrum of an ordered sample. The four grey areas are used to calculate the degree of ordering.

FIG. 14a and FIG. 14b show SEM images of a material of the invention in perspective and in cross-section, respectively.

FIG. 15a and FIG. 15b show SEM images of a commercial material in perspective and in cross-section, respectively.

### DETAILED DESCRIPTION OF THE FIGURES

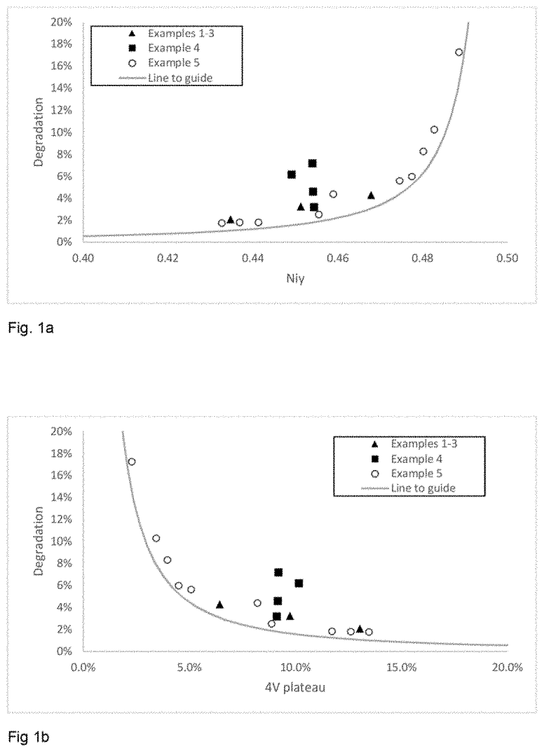

FIG. 1a shows experimental data on the relation between degradation and the nickel content (the value yin LiₓNi_{y}Mn_{2-y}O₄, indicated in FIG. 1a as “Niy”) in the spinel for a range of lithium positive electrode active materials. All samples show a capacity of at least 138 mAh/g when discharged at 74 mA/g (0.5 C) in half cells at 55° C. between 3.5 V and 5 V as described in Example A. The degradation is measured in half cells at 55° C. and stated as degradation per 100 full charge and discharge cycles between 3.5 V and 5 V as described in Example A. Degradation is affected by several factors, which causes variation, but a line or curve to guide has been drawn to emphasize that at a given Ni content of the spinel, a minimum degradation rate exists and the minimum degradation rate decreases with decreasing Ni content. Thus, it is not possible to provide a lithium positive electrode active material with a lower degradation rate than the minimum degradation rate; however, inhomogeneities, morphologies and/or too much ordering in a lithium positive electrode active material may make it difficult to reach the minimum degradation rate. To explain some of these other parameters, four samples (black squares) have been produced to investigate how morphology affects degradation as discussed in Example 4.

FIG. 1b shows experimental data on the relation between the 4V plateau of the lithium positive electrode active material in a half cell and the degradation for a range of lithium positive electrode active materials. All samples show a capacity of at least 138 mAh/g when discharged at 74 mA/g (0.5 C) in half cells at 55° C. between 3.5 V and 5 V as described in Example A. The degradation is measured in half cells at 55° C. and stated as degradation per 100 full charge and discharge cycles between 3.5 V and 5 V as described in Example A. Also in FIG. 1b, a line or curve to guide has been drawn to emphasize that at a given 4V plateau, a minimum degradation rate exists and the minimum degradation rate decreases with increasing 4V plateau. The four samples indicated with black squares in FIG. 1a, are also shown as black squares in FIG. 1b.

FIG. 1c shows experimental data on the relation between the lattice parameter a, “a axis”, in the spinel of the lithium positive electrode active material and the degradation for a range of lithium positive electrode active materials. All samples show a capacity of at least 138 mAh/g when discharged at 74 mA/g (0.5 C) in half cells at 55° C. between 3.5 V and 5 V as described in Example A. The degradation is measured in half cells at 55° C. and stated as degradation per 100 full charge and discharge cycles between 3.5 V and 5 V as described in Example A. Also in FIG. 1c, a line or curve to guide has been drawn to emphasize that for a given lattice parameter a, a minimum degradation rate exists and the minimum degradation rate decreases with increasing lattice parameter a. The four samples indicated with black squares in FIGS. 1a and 1b, are also shown as black squares in FIG. 1c. FIGS. 1a, 1b and 1c show relations between different parameters for the same samples.

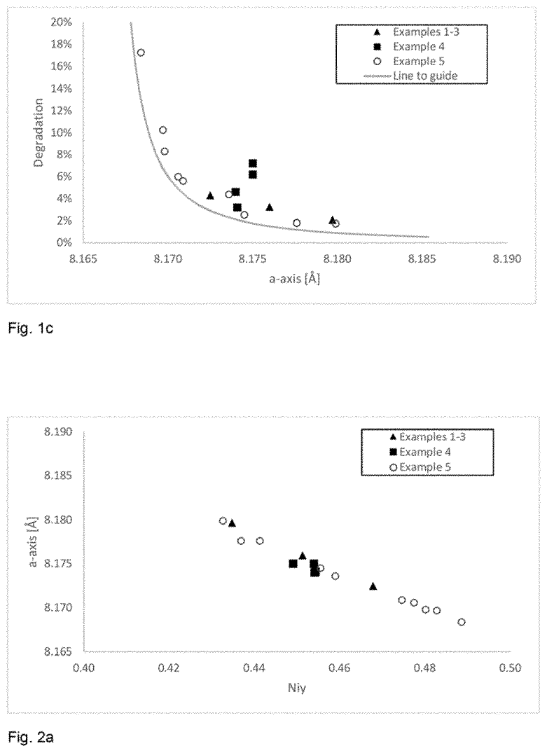

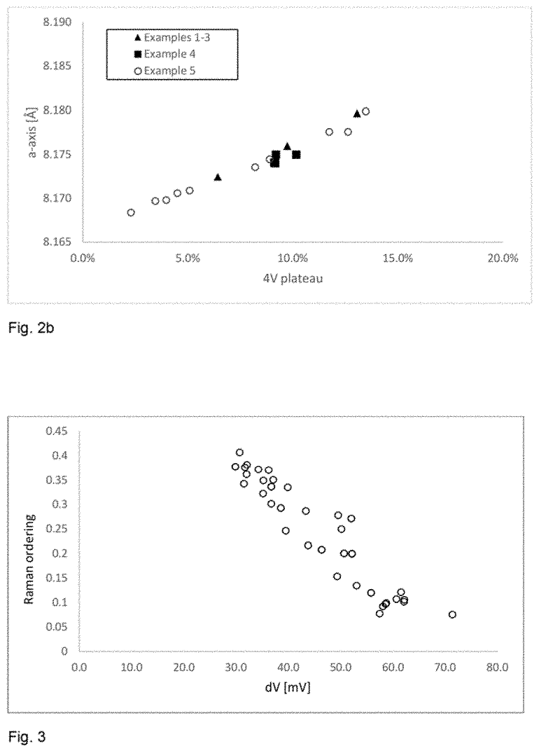

FIG. 2a shows experimental data on the relation between the nickel content (via. the value y in LiₓNi_{y}Mn_{2-y}O₄, indicated in FIG. 2a as “Niy”) in the spinel and the lattice parameter a of the spinel for a range of lithium positive electrode active materials. All samples show a capacity of at least 138 mAh/g when discharged at 74 mA/g (0.5 C) in half cells at 55° C. between 3.5 V and 5 V as described in Example A. From FIG. 2a it is seen that for the experimental data, a linear dependence exists between the content of nickel and the lattice parameter a. Small variations could occur due to variations in lithium content.

FIG. 2b shows experimental data on the relation between the 4V plateau of the lithium positive electrode active material in a half cell and the lattice parameter a of the spinel for a range of lithium positive electrode active materials. All samples show a capacity of at least 138 mAh/g when discharged at 74 mA/g (0.5 C) in half cells at 55° C. between 3.5 V and 5 V as described in Example A. FIGS. 2a and 2b show relations between different parameters for the same samples.

As discussed in Example C, a correlation exists between the Ni content in the spinel and the lattice parameter a of the spinel, because a lower amount of Ni will result in a higher content of Mn³⁺.

Thus, the inventors have realized that a close correlation exists between low degradation, the a parameter, the Ni content and the 4V plateau of the lithium positive electrode active material. This correlation may be used for selecting appropriate values of a parameter, Ni content to optimize the lithium positive electrode active material for specific applications.

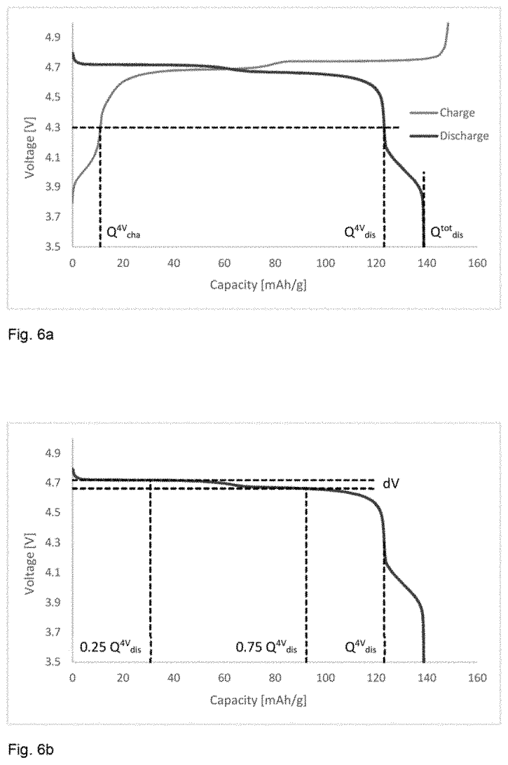

FIG. 3 shows experimental data on the relation between cation ordering parameters determined using Raman spectroscopy and electrochemistry, respectively. The two methods are described in Example D, and it is seen a correlation exists. It has been observed that a disordered lithium positive electrode active material provides for a lower degradation compared to a similar material prepared as an ordered material. Even though the samples shown in FIG. 3 have some variation, a tendency exists indicating higher dV values correspond to lower Raman ordering values. The voltage difference, dV, is measured as described in relation to FIG. 6b. As used herein, the term “Raman ordering” is meant to denote a measurement of cation ordering within the lithium positive electrode active material based on Raman spectroscopy as described in Example D.

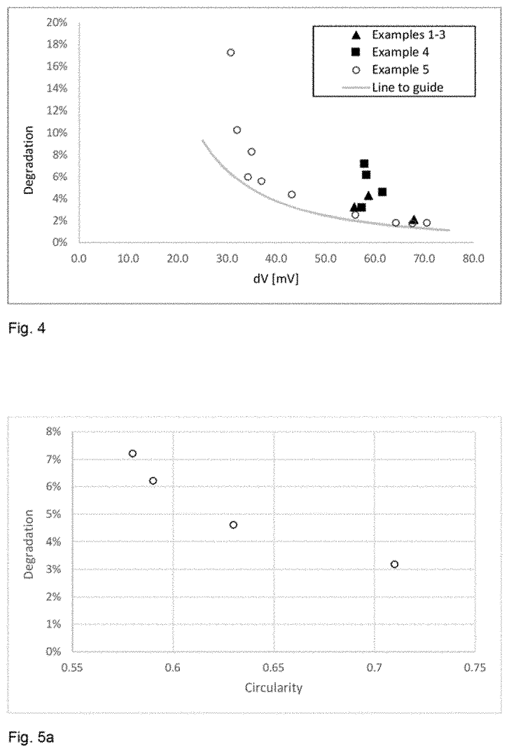

FIG. 4 shows experimental data on the relation between degradation and the discharge difference in a half-cell between the potentials at 25% and 75% of the capacity above 4.3 V during discharge with a current of around 29 mA/g for a range of lithium positive electrode active materials. The difference, dV, is measured as described Example D. In FIG. 4, it is shown that a relation exists between the difference dV and the degradation of the lithium positive electrode active materials. The difference dV is also denoted “plateau separation” and is a measure of the free energies related to insertion and removal of lithium at a given state of charge and this is influenced by whether the spinel phase is disordered or ordered. Even though the samples shown in FIG. 4 have some variation, a tendency exists indicating higher dV values correspond to lower degradation. Without being bound by theory, a plateau separation of at least 50 mV seems advantageous since this is related to whether the lithium positive electrode active material is in an ordered or a disordered phase and to the fade rate of a half cell with the lithium positive electrode active material.

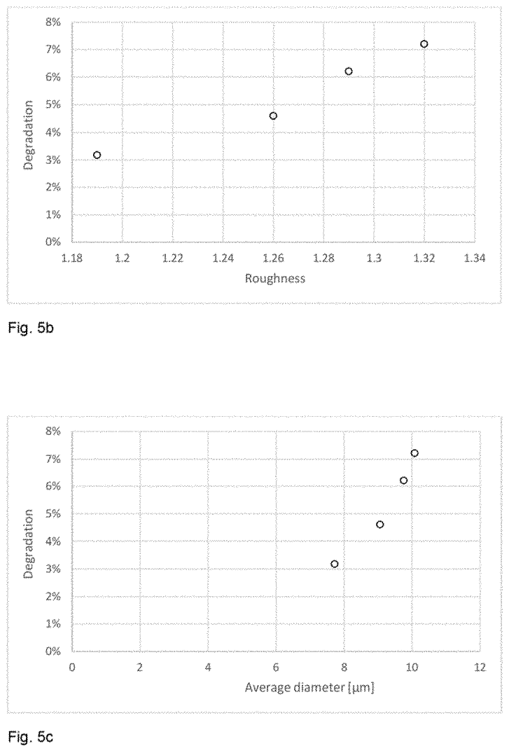

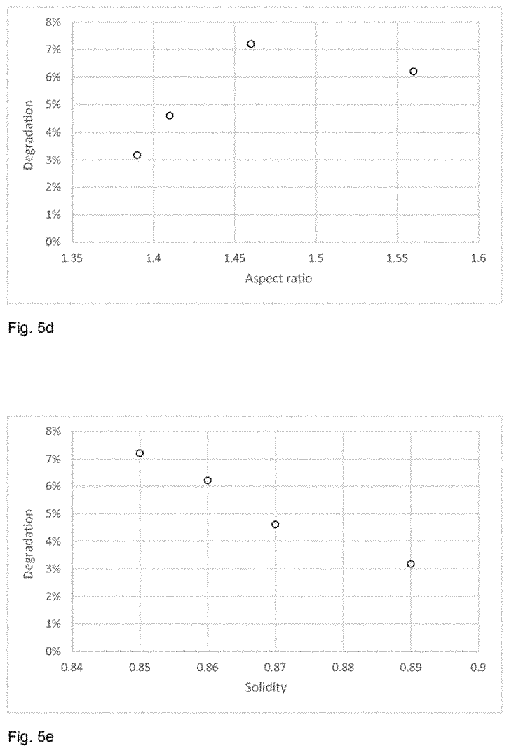

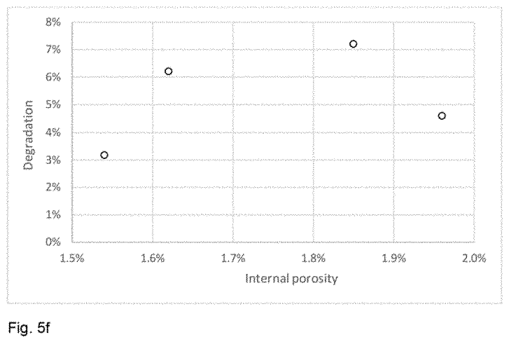

FIGS. 5a-5f show the relationship between degradation and a range of parameters for the four samples indicated with black squares in FIGS. 1a-1c, 2a-2b and 4. These four samples of lithium positive electrode active materials have differing degradations values as it is clear from FIGS. 1a-1c and 2a-2b, but very similar spinel stoichiometries. Of the four samples shown in FIG. 5a-5f, the spinel of three of the samples has the spinel stoichiometry LiNi_{0.454}Mn_{1.546}O₄, whilst the spinel of the fourth sample has the spinel stoichiometry LiNi_{0.449}Mn_{1.551}O₄. The four samples are all prepared based on co-precipitated precursors and the particles are secondary particles.

FIG. 5a shows the relationship between circularity of secondary particles and degradation for four samples of a lithium positive electrode active material according to the invention and with substantially the same spinel stoichiometry. The circularity of a secondary particle is measured from the area and the perimeter of the particle shape as 4π*[Area]/[Perimeter]². Circularity describes both overall shape and surface roughness, where a higher value means more circular shape and smoother surface. A circle with a smooth surface has circularity 1. Average circularity is the arithmetic mean of the circularities of all secondary particles measured in a sample. Calculated using the software ImageJ (https://imagej.nih.gov). In FIG. 5a it is seen that higher value of circularity corresponds to lower degradation.

FIG. 5b shows the relationship between roughness of secondary particles and degradation for four samples of a lithium positive electrode active material according to the invention and with substantially the same spinel stoichiometry. The roughness of a secondary particle is measured as the ratio between the perimeter and the perimeter of an ellipse fitted to the particle shape. Roughness describes how rough the surface is, where a higher value means rougher surface. Average roughness is the arithmetic mean of the roughnesses of all secondary particles measured in a sample. Calculated using the software ImageJ (https://imaqej.nih.gov). In FIG. 5b it is seen that lower value of roughness corresponds to lower degradation.

FIG. 5c shows the relationship between average diameter of secondary particles and degradation for four samples of a lithium positive electrode active material according to the invention and with substantially the same spinel stoichiometry. The diameter of a secondary particle is measured as the equivalent circle diameter, i.e. the diameter of a circle with the same area as the particle. Average diameter is the arithmetic mean of the diameters of all secondary particles measured in a sample. Calculated using the software ImageJ (https://imagej.nih.gov). In FIG. 5c it is seen that a lower average diameter to lower degradation. The average diameter of secondary particles is given in μm.

FIG. 5d shows the relationship between aspect ratio of secondary particles and degradation for four samples of a lithium positive electrode active material according to the invention and with substantially the same spinel stoichiometry. The aspect ratio of a secondary particle is measured from an ellipse fitted to the particle shape. The aspect ratio is defined as [Major axis]/[Minor Axis] where Major axis and Minor Axis are the major and minor axes of the fitted ellipse. Average aspect ratio is the arithmetic mean of the aspect ratios of all secondary particles measured in a sample. Calculated using the software ImageJ (https://imaqej.nih.gov). In FIG. 5d it is seen that a lower aspect ratio in general corresponds to lower degradation.

FIG. 5e shows the relationship between solidity of secondary particles and degradation for four samples of a lithium positive electrode active material according to the invention and with substantially the same spinel stoichiometry. The solidity of a secondary particle is defined as the ratio between the particle area and the area of the convex area, i.e. [Area]/[Convex Area]. The convex area can be thought of as the shape resulting from wrapping a rubber band around the particle. The more concave features in a particle's surface, the higher is the convex area and the lower is the solidity. Average solidity is the arithmetic mean of the solidities of all secondary particles measured in a sample. Calculated using the software ImageJ (https://imagej.nih.gov). In FIG. 5e it is seen that higher values of solidity correspond to lower degradation.

FIG. 5f shows the relationship between porosity of secondary particles and degradation for four samples of a lithium positive electrode active material according to the invention and with substantially the same spinel stoichiometry. The porosity of a secondary particle is the percentage of the internal area that appears with dark contrast in the SEM image, where dark contrast is interpreted as a porosity, i.e. a hole inside the particle. Average porosity is the arithmetic mean of the porosities of all secondary particles measured in a sample. Calculated using the software ImageJ (https://imagej.nih.gov). In FIG. 5f it is seen that a lower value of porosity in general corresponds to lower degradation.

FIGS. 6a and 6b show the relationship between capacity and the voltage for a half cell with the lithium positive electrode active material during discharging and charging for determination of 4V plateau and dV, respectively. The measurement used as example to calculate the two parameters is based on the lithium positive electrode active material described in Example 2. The 4V plateau is used to describe the capacity around 4V compared to the total capacity. This ratio may vary slightly between charge and discharge, and thus the value is determined as an average of the two. Using variable names from the figure, the 4V plateau is calculated as (Q^{4V}_{cha}+(Q^{tot}_{dis}−Q^{4V}_{dis}))/(2*Q^{tot}_{dis}). Based on the example, the value is calculated as: (11.0+(138.8−123.1))/(2*138.8)=9.6%. The plateau separation, dV, between the two plateaus at around 4.7 V is calculated as the difference in voltage between the potentials at 25% and 75% of the discharge capacity between 4.3 V and 5 V during discharge at 29.6 mA/g. Using the example shown in FIG. 6b, this is calculated as 4.718V−4.662 V=56 mV.

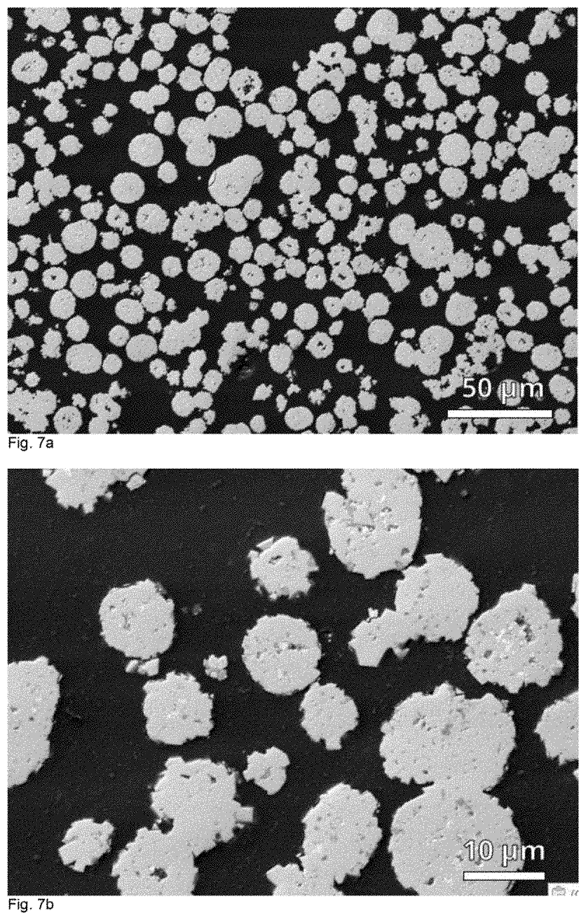

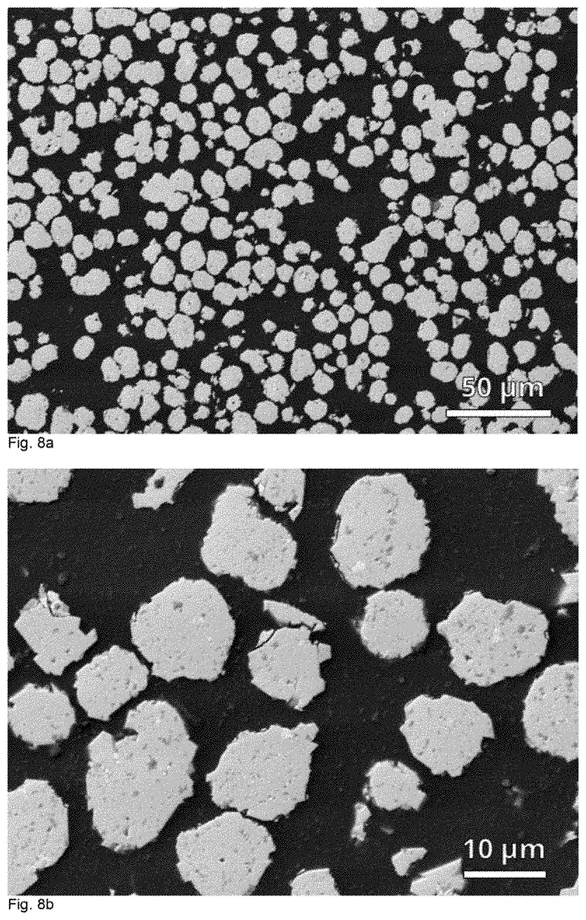

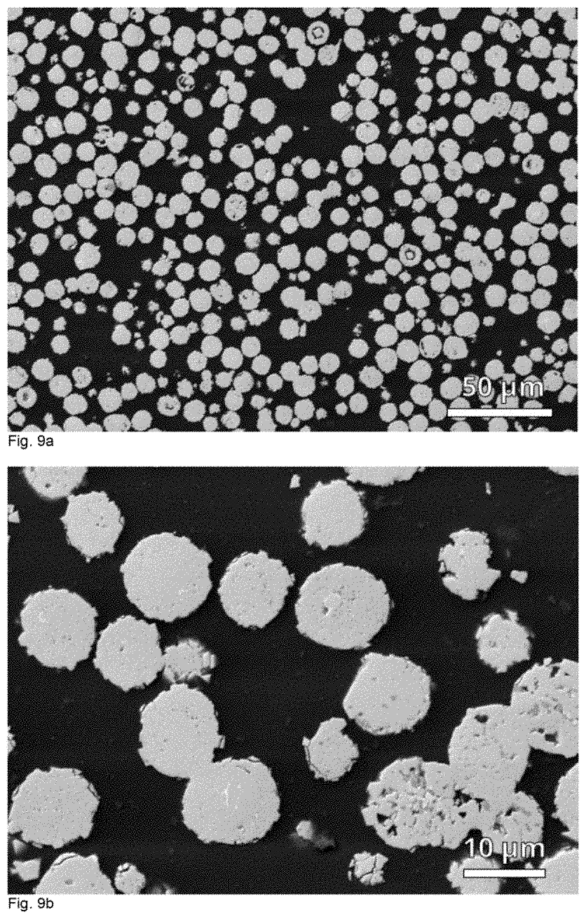

FIGS. 7a-10b are SEM images at two different magnification levels for the four materials indicated with black squares in FIGS. 1a-1c and 2a-2b. These four materials have differing degradations values as it is clear from FIGS. 1a-1c and 2a-2b. In the samples of FIGS. 7a, 7b, 9a, 9b, 10a and 10b, the spinel has the stoichiometry LiNi_{0.454}Mn_{1.546}O₄, whilst the spinel of the sample of FIGS. 8a and 8b has the stoichiometry LiNi_{0.449}Mn_{1.551}O₄.

FIGS. 7a and 7b are SEM images at two different magnification levels of one of the samples depicted in FIGS. 1a-1c, 2a-2b and 5a-5f. The sample shown in FIGS. 7a and 7b is the lithium positive electrode active material having a degradation of 7.2%. The sample material was embedded in epoxy and polished to a flat surface in order to image cross sections of the secondary particles of the lithium positive electrode active material. Images were acquired using an acceleration voltage of 8 kV and the backscatter electron detector. Pixel size: a) 0.216 μm/pixel and b) 0.054 μm/pixel.

FIGS. 8a and 8b are SEM images at two different magnifications levels second of the samples depicted in FIGS. 1a-1c, 2a-2b and FIGS. 5a-5f. The sample shown in FIGS. 8a and 8b is the lithium positive electrode active material having a degradation of 6.2%. The sample material was embedded in epoxy and polished to a flat surface in order to image cross sections of the secondary particles of the lithium positive electrode active material. Images were acquired using an acceleration voltage of 8 kV and the backscatter electron detector. Pixel size: a) 0.216 μm/pixel and b) 0.054 μm/pixel.

FIGS. 9a and 9b are SEM images at two different magnifications levels of third of the samples depicted in FIGS. 1a-1c, 2a-2b and 5a-5f. The sample shown in FIGS. 9a and 9b is the lithium positive electrode active material having a degradation of 4.6%. The sample material was embedded in epoxy and polished to a flat surface in order to image cross sections of the secondary particles of the lithium positive electrode active material. Images were acquired using an acceleration voltage of 8 kV and the backscatter electron detector. Pixel size: a) 0.216 μm/pixel and b) 0.054 μm/pixel.

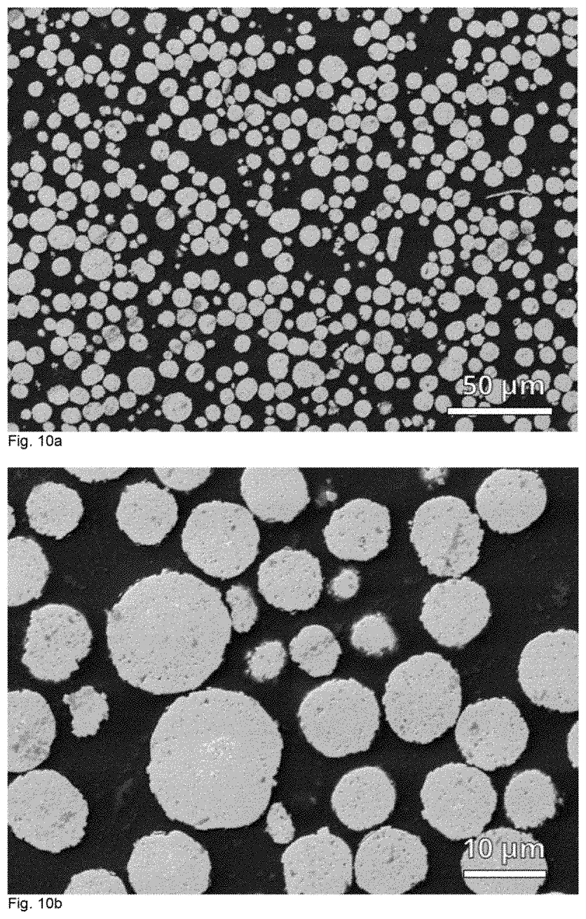

FIGS. 10a and 10b are SEM images at different magnifications levels of a fourth of the samples depicted in FIGS. 1a-1c, 2a-2b and 5a-5f. The sample shown in FIGS. 10a and 10b is the lithium positive electrode active material having a degradation of 3.2%.

The sample material was embedded in epoxy and polished to a flat surface in order to image cross sections of the secondary particles of the lithium positive electrode active material. Images were acquired using an acceleration voltage of 8 kV and the backscatter electron detector. Pixel size: a) 0.216 μm/pixel and b) 0.054 μm/pixel.

FIG. 11 shows the Ni content of the spinel, Niy, measured by scanning transmission electron microscopy energy dispersive x-ray spectroscopy (STEM-EDS) compared to values from electro chemistry (EC) for three samples with different values of Niy. STEM-EDS directly measures the elemental composition of a material and EC indirectly measures the composition from the size of the 4V charge plateau. The comparison shows that the two methods agree and that the 4V charge plateau is indeed directly related to the composition of the spinel phase. Therefore, the determination of the 4V charge plateau is a valid method for determining the composition of the spinel.

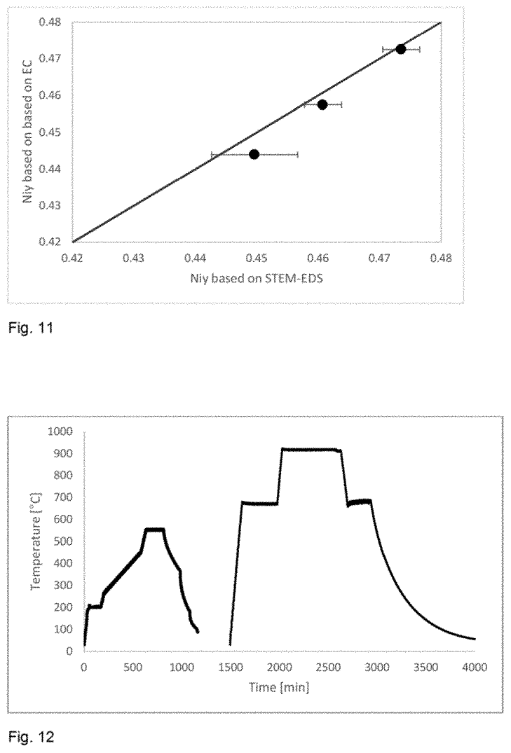

FIG. 12 shows the heating profile used to obtain the cathode electrode active material described in Example 2. The temperature is measured with a thermocouple in close proximity of the powder bed. The heating is divided in two stages as described in Example 2.

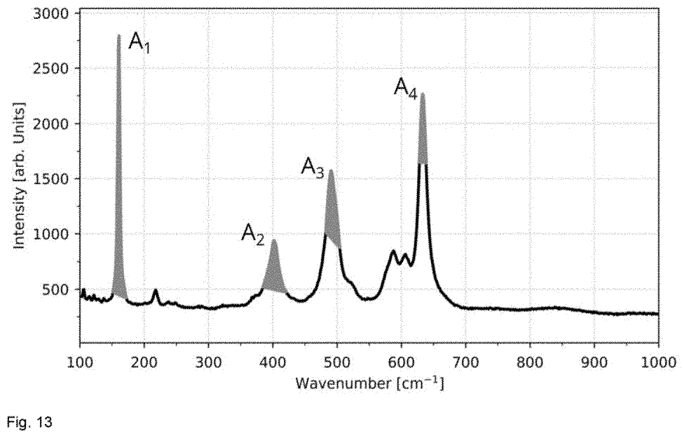

FIG. 13 shows a Raman spectrum of an ordered spinel. The four grey areas between 151 cm⁻¹-172 cm⁻¹, 385 cm⁻¹-420 cm⁻¹, 482 cm⁻¹-505 cm⁻¹ and 627 cm⁻¹-639 cm⁻¹, respectively, are used to calculate the degree of ordering.

### EXAMPLES

In the following, exemplary and non-limiting embodiments of the invention are described in the form of experimental data. Examples 1-5 relate to methods of preparation of the lithium positive electrode active material. Example A describes a method of electrochemical testing, Example B describes SEM based measurement of morphological parameters, Example C describes three methods to determine the content of Mn and Ni in the spinel, and Example D describes two methods used to determine the degree of cation ordering in the spinel.

### Example 1: Synthesis of Lithium Positive Electrode Active Material

A metal ion solution of NiSO₄ and MnSO₄ with a Ni:Mn atomic ratio of 1:3.18 is prepared by dissolving 7.1 kg of NiSO₄.7H₂O and 15.1 kg of MnSO₄.H₂O in 48.5 kg water. In a separate container, a carbonate solution is prepared by dissolving 11.2 kg of Na₂CO₃ in 51.0 kg water. No ammonia or other chelating agents are used. The metal ion solution and the carbonate solution are added separately with around 3 L/h each into a reactor provided with vigorous stirring (400 rpm), pH between 8.8 and 9.5 and a temperature of 35° C. The volume of the reactor is 40 liters. The product is removed from the reactor after 4 hours and divided into six. Precipitation is continued on one of the six batches for around 4 hours, after which it is divided into two. Precipitation is continued on each of the two batches until the desired Ni,Mn-carbonate precursor is obtained. This procedure is followed for the remaining five samples. The precursor is filtrated and washed to remove Na₂SO₄.

Precursors in the form of 4667 g co-precipitated Ni,Mn-carbonate (Ni: 0.478, Mn: 1.522) produced as described above and 716 g Li₂CO₃ (corresponding to Li:Ni:Mn=1.00:0.478:1.522) are mixed with ethanol to form a viscous slurry. The slurry is shaken in a paint shaker for 3 min. in order to obtain full de-agglomeration and mixing of the particulate materials. The slurry is poured into trays and left to dry at 80° C. The dried material is further de-agglomerated by shaking in a paint shaker for 1 min. in order to obtain a free flowing homogeneous powder mix.

The powder mix is heated in a furnace with nitrogen flow with a ramp of 2.5° C./min to 550° C. The powder is heated 4 hours at 550° C. Hereafter the powder is treated for 9 hours in air at 550° C. The temperature is increased to 950° C. with a ramp of 2.5° C./min. A temperature of 950° C. is maintained for 10 hours and decreased to 700° C. with a ramp of 2.5° C./min. A temperature of 700° C. is maintained for 4 hours and decreased to room temperature with a ramp of 2.5° C./min.

Subsequently, 20 g powder is heated to 900° C. in oxygen enriched air (90% O₂) with a ramp of 2.5° C./min. A temperature of 900° C. is maintained for 1 hour and decreased to 750° C. with a ramp of 2.5° C./min to 750° C. A temperature of 750° C. is maintained for 4 hours and decreased to room temperature with a ramp of 2.5° C./min.

The powder is again de-agglomerated by shaking for 6 min in a paint shaker and passed through a 45-micron sieve resulting in lithium positive electrode active material consisting of 97.7% LNMO, 1.5% O3 and 0.8% rock salt. Using methods described in Example A and C, the stoichiometry of the spinel is determined to be LiNi_{0.47}Mn_{1.53}O₄, the 4V plateau constitute 6% of the total discharge capacity and the degradation at 55° C. is measured to be 4% per 100 cycles in half cells. Relevant parameters are listed in Table 1 below.

### Example 2: Synthesis of Lithium Positive Electrode Active Material

Precursors in the form of 529 g co-precipitated Ni,Mn-carbonate (Ni: 0.46, Mn: 1.54) produced as described in Example 1 and 83.1 g Li₂CO₃ (corresponding to Li:Ni:Mn=1.00:0.46:1.54) are mixed with ethanol to form a viscous slurry. The slurry is shaken in a paint shaker for 3 min. in order to obtain full de-agglomeration and mixing of the particulate materials. The slurry is poured into trays and left to dry at 80° C. The dried material is further de-agglomerated by shaking in a paint shaker for 1 min. in or-der to obtain a free flowing homogeneous powder mix.

The powder mix is heated in a muffle furnace with nitrogen flow with a ramp of around 1° C./min to 550° C. A temperature of 550° C. is maintained for 3 hours and cooled to room temperature with a ramp of around 1° C./min.

This product is de-agglomerated by shaking for 6 min. in a paint shaker, passed through a 45-micron sieve and distributed in a 10-25 mm layer in alumina crucibles. The powder is heated in a muffle furnace in air with a ramp of 2.5° C./min to 670° C. A temperature of 670° C. is maintained for 6 hours and increased further to 900° C. with a ramp of 2.5° C./min. A temperature of 900° C. is maintained for 10 hours and decreased to 700° C. with a ramp of 2.5° C./min. A temperature of 700° C. is maintained for 4 hours and decreased to room temperature with a ramp of 2.5° C./min.

The powder is again de-agglomerated by shaking for 6 min. in a paint shaker and passed through a 45-micron sieve resulting in lithium positive electrode active material consisting of 98.9% LNMO, 0.5% 03 and 0.6% rock salt. Using methods described in Example A and C, the stoichiometry of the spinel is determined to be LiNi_{0.45}Mn_{1.55}O₄, the 4V plateau constitute 10% of the total discharge capacity and the degradation at 55° C. is measured to be 3% per 100 cycles in half cells. Relevant parameters are listed in Table 1 below.

### Example 3: Synthesis of Lithium Positive Electrode Active Material

Precursors in the form of 1400 g co-precipitated Ni,Mn-carbonate (Ni: 0.47, Mn: 1.53) produced as described in Example 1 and 211 g Li₂CO₃ (corresponding to Li:Ni:Mn=0.98:0.47:1.53) are mixed with ethanol to form a viscous slurry. The slurry is shaken in a paint shaker for 3 min. in order to obtain full de-agglomeration and mixing of the particulate materials. The slurry is poured into trays and left to dry at 80° C. The dried material is further de-agglomerated by shaking in a paint shaker for 1 min. in order to obtain a free flowing homogeneous powder mix.

The powder mix is heated in a furnace with nitrogen flow with a ramp of 2° C./min to 600° C. A temperature of 600° C. is maintained for 6 hours. Hereafter the powder is heated for 12 hours in air at 600° C. The temperature is increased to 900° C. with a ramp of 2° C./min. A temperature of 900° C. is maintained for 5 hours and decreased to 750° C. with a ramp of 2° C./min. A temperature of 750° C. is maintained for 8 hours and decreased to room temperature with a ramp of 2° C./min.

The powder is again de-agglomerated by shaking for 6 min. in a paint shaker and passed through a 45-micron sieve resulting in lithium positive electrode active material consisting of 98.1% LNMO, 1.4% 03 and 0.5% rock salt. Using methods described in Example A and C, the stoichiometry of the spinel is determined to be LiNi_{0.43}Mn_{1.57}O₄, the 4V plateau constitutes 13% of the total discharge capacity and the degradation at 55° C. is measured to be 2% per 100 cycles in half cells. Relevant parameters are listed in Table 1 below.

### Example 4: Synthesis of Lithium Positive Electrode Active Material

Four samples have been synthesized in order to obtain different morphologies of the particles, while maintaining the same Ni content in the spinel. The four samples are included in FIGS. 1a-1c, 2a-2b and 4 as black squares, FIGS. 7a-10b show SEM images of particle cross sections, and FIGS. 5a-5f show the relationship between degradation and a range of parameters related to morphology for the four samples. Relevant parameters are listed in Table 1 below. Precursors for all samples has been co-precipitated as described in Example 1, using slightly different variations. As an example, the precursor of sample 2 in Table 2 as shown in FIGS. 8a and 8b is produced with a stirring of 200 rpm corresponding to around 2.6 W/L in a filled reactor and the precursor of sample 4 in Table 2 as shown in FIGS. 10a and 10b is produced with a stirring of 400 rpm corresponding to around 10 W/L in a filled reactor.

### Example 5: Synthesis of Lithium Positive Electrode Active Material

Additional samples have been prepared as Examples 1-3 using different precursors and different calcination programs. FIG. 1a shows the correlation between degradation per 100 cycles at 55° C. measured in half cells as described in Example A and the Ni content in the spinel. The Ni content in the spinel is determined electrochemically as described in Example C. FIG. 1b shows the correlation between degradation per 100 cycles at 55° C. measured in half cells as described in Example A and the 4V plateau. FIG. 1c shows the correlation between degradation at 55° C. measured in half cells as described in Example A and the lattice parameter a in the spinel. Table 1 below contains the Ni content, Niy, the lattice parameter, a, the 4V plateau, the capacity, degradation and the difference, dV, between the two Ni-plateaus as described in Example D for the samples described in Examples 1-5.

TABLE 1

| | | | | | |
|---|---|---|---|---|---|
| | a-axis | 4 V | Capacity | Degradation per | dV |
| Niy | (Å) | plateau | (mAh/g) | 100 cycles | (mV) |

Examples 1-3

| | | | | | |
|---|---|---|---|---|---|
| 0.47 | 8.173 | 6% | 140 | 4% | 59 |
| 0.45 | 8.176 | 10% | 140 | 3% | 56 |
| 0.43 | 8.180 | 13% | 140 | 2% | 68 |

Example 4

| | | | | | |
|---|---|---|---|---|---|
| 0.454 | 8.175 | 9% | 136 | 7% | 58 |
| 0.449 | 8.175 | 10% | 135 | 6% | 58 |
| 0.454 | 8.174 | 9% | 138 | 5% | 62 |
| 0.454 | 8.174 | 9% | 138 | 3% | 57 |

Example 5

| | | | | | |
|---|---|---|---|---|---|
| 0.43 | 8.180 | 13% | 138 | 2% | 68 |
| 0.44 | 8.178 | 13% | 138 | 2% | 71 |
| 0.44 | 8.178 | 12% | 138 | 2% | 64 |
| 0.46 | 8.175 | 9% | 140 | 3% | 56 |
| 0.46 | 8.174 | 8% | 141 | 4% | 43 |
| 0.47 | 8.171 | 5% | 142 | 6% | 37 |
| 0.48 | 8.171 | 5% | 138 | 6% | 34 |
| 0.48 | 8.170 | 4% | 139 | 8% | 35 |
| 0.48 | 8.170 | 3% | 139 | 10% | 32 |
| 0.49 | 8.168 | 2% | 138 | 17% | 31 |

### Example 6: Determination of Shape Using Scanning Electron Microscopy: Comparison of Sample According to the Invention (Sample 4) and Commercial Sample

Sample 4 as discussed in Example 4 and a sample of a commercial product of lithium positive electrode active material were compared using Scanning Electron Microscopy (SEM).

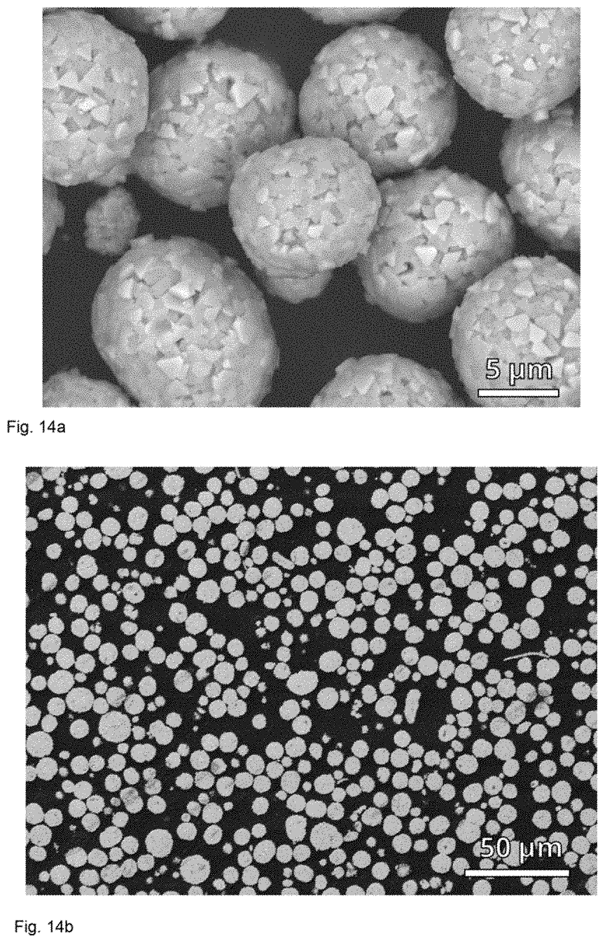

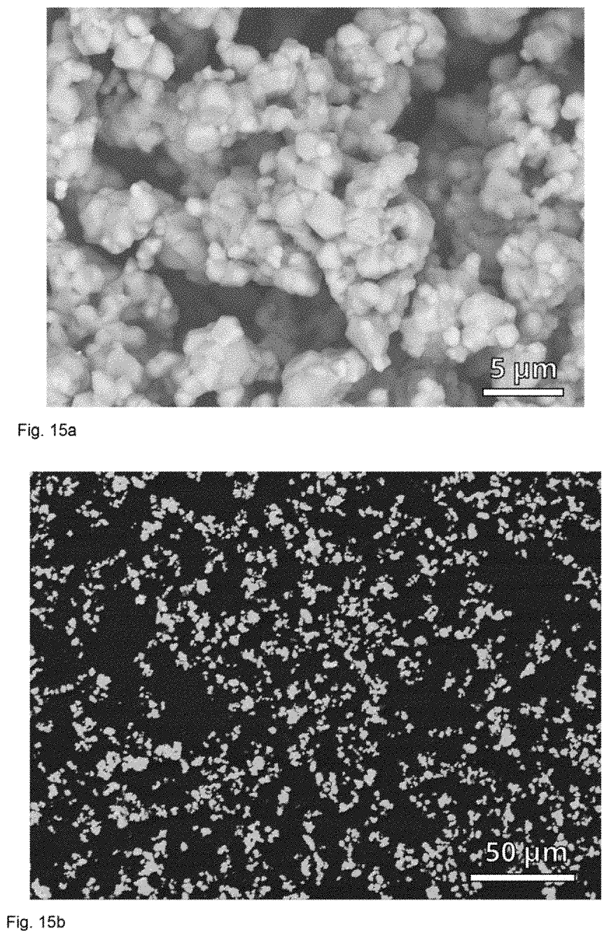

FIG. 14a and FIG. 14b show SEM images of the Sample 4 in perspective and in cross-section, respectively, and FIG. 15a and FIG. 15b show SEM images of the commercial sample in perspective and in cross-section, respectively. As will appear from FIG. 14a and FIG. 14b, the particles of Sample 4 are highly spherical and highly uniform in their internal structure. In comparison, the particles of the commercial sample (FIG. 15a and FIG. 15b) are not spherical and appear to have a high degree of agglomeration.

### Example A: Method of Electrochemical Testing of Lithium Positive Electrode Active Materials Prepared According to Examples 1 to 5

Electrochemical tests have been realized in 2032 type coin cells, using thin composite positive electrodes and metallic lithium negative electrodes (half-cells). The thin composite positive electrodes were prepared by thoroughly mixing 84 wt % of lithium positive electrode active material (prepared according to Examples 1-4) with 8 wt % Super C65 carbon black (Timcal) and 8 wt % PVdF binder (polyvinylidene difluoride, Sigma Aldrich) in NMP (N-methyl-pyrrolidone) to form a slurry. The slurries were spread onto carbon coated aluminum foils using a doctor blade with a 100-200 μm gap and dried for 12 hours at 80° C. to form films. Electrodes with a diameter of 14 mm and a loading of approximately 8 mg of lithium positive electrode active material were cut from the dried films, pressed in a hydraulic pellet press (diameter 20 mm; 3 tonnes) and subjected to 10 hours drying at 120° C. under vacuum in an argon filled glove box.

Coin cells were assembled in argon filled glove box (<1 ppm O₂ and H₂O) using two polymer separators (Toray V25EKD and Freudenberg FS2192-11SG) and electrolyte containing 1 molar LiPF₆ in EC:DMC (1:1 in weight). Two 250 μm thick lithium disks were used as counter electrodes and the pressure in the cells were regulated with two stainless steel disk spacers and a disk spring on the negative electrode side. Electrochemical lithium insertion and extraction were monitored with an automatic cycling data recording system (Maccor) operating in galvanostatic mode.

The electrochemical test contains 6 formation cycles (3 cycles 0.2 C/0.2 C (charge/discharge) and 3 cycles 0.5 C/0.2 C), 25 power test cycles (5 cycles 0.5 C/0.5 C, 5 cycles 0.5 C/1 C, 5 cycles 0.5 C/2 C, 5 cycles 0.5 C/5 C, 5 cycles 0.5 C/10 C), and then 120 0.5 C/1 C cycles to measure degradation. C-rates were calculated based on the theoretical specific capacity of the lithium positive electrode active material of 147 mAhg⁻¹; thus, for example 0.2 C corresponds to 29.6 mAg⁻¹ and 10 C corresponds to 1.47 Ag⁻¹. The voltage separation of the two plateaus at 4.7 V, dV, and the 4V plateau are calculated based on cycle 3, the capacity is calculated based on cycle 7, and the degradation is calculated between cycle 33 and cycle 133.

### Example B: Method of Measuring Particle Size and Shape Using Scanning Electron Microscopy

To prepare samples for scanning electron microscopy (SEM), the lithium positive electrode active material was embedded in epoxy and polished to a flat surface in order to image cross sections of the particles. SEM images acquired of the embedded cross sections were used to measure particle size and shape of different samples in order to evaluate the correlation between particle shape and degradation for samples with substantially the same stoichiometry of the spinel phase. In the samples of FIGS. 7a, 7b, 9a, 9b, 10a and 10b, the spinel has the stoichiometry LiNi_{0.454}Mn_{1.546}O₄, whilst the spinel of the sample of FIGS. 8a and 8b has the stoichiometry LiNi_{0.449}Mn_{1.551}O₄.

SEM images were acquired using an acceleration voltage of 8 kV and the backscatter electron detector. Images were acquired at low and high magnification with pixel sizes 0.216 μm/pixel (FIGS. 7a, 8a, 9a, 10a) and 0.054 μm/pixel (FIG. 7b, 8b, 9b, 10b), respectively. The low magnification images were used for measuring particle size and shape.

SEM images were analyzed using the software ImageJ (https://imagej.nih.gov). The procedure was the following:
Median filter, with 1 pixel radius;
Sharpen;
Threshold using the Otsu algorithm; and
Analyze particles: Only particles with area larger than 3 μm² considered.

The step of analyzing particles includes measuring area and perimeter for each particle and calculating a best fit ellipse having the same area as the particle. Area, perimeter and fitted ellipse are then used to calculate a number of descriptors for size and shape for each particle in the SEM image:
Diameter: Equivalent circle diameter, i.e. the diameter of a circle with the same area as the particle.
Aspect ratio: The aspect ratio of the particle's fitted ellipse, i.e. [Major axis]/[Minor Axis].
Roughness: Ratio between measured perimeter and the perimeter of the fitted ellipse. Describes the surface roughness of the particle.
Circularity: 4π*[Area]/[Perimeter]². Circularity describes overall shape and surface roughness. A circle with a smooth surface has a circularity of 1.
Solidity: [Area]/[Convex Area]. Convex area can be thought of as the shape resulting from wrapping a rubber band around the particle. The more concave features in a particle's surface, the higher is the convex area and the lower is the solidity.
Porosity: The percentage of the internal area of a particle that appears with dark contrast in the SEM image, where dark contrast is interpreted as a porosity, i.e. a hole inside the particle.

The sample average value of these descriptors is shown in the table below for the four samples with substantially the same spinel stoichiometry and different degradation. Degradation is measured in a half cell as the decrease in capacity after 100 cycles between 3.5 to 5.0 V at 55° C.

TABLE 2

| | Number of | | Aspect | | | | | |
|---|---|---|---|---|---|---|---|---|
| Sample | particles | Diameter | ratio | Roughness | Circularity | Solidity | Porosity | Degradation |
| 1 | 633 | 10.1 μm | 1.46 | 1.32 | 0.58 | 0.85 | 1.9% | 7% |
| 2 | 764 | 9.8 μm | 1.56 | 1.29 | 0.59 | 0.86 | 1.6% | 6% |
| 3 | 896 | 9.1 μm | 1.41 | 1.26 | 0.63 | 0.87 | 2.0% | 5% |
| 4 | 1250 | 7.7 μm | 1.39 | 1.19 | 0.71 | 0.89 | 1.5% | 3% |

As described in relation to FIGS. 5a-5f, degradation as a function of the six descriptors shows a correlation in such a way that a lithium positive electrode active material with a low degradation is characterized by one or more of the following parameters: Low diameter, low roughness, low aspect ratio, high circularity, high solidity and low porosity. Optimally, a lithium positive electrode active material would fulfill most of or all of the six descriptors: Low diameter, low roughness, low aspect ratio, high circularity, high solidity and low porosity. Preferably, diameter is below 10 μm, roughness is below 1.35, circularity is above 0.55 and solidity is above 0.8.

### Example C: Determination of the Ni and Mn Content in the Spinel

As described above, depending on the preparation of the lithium positive electrode active material, the content of Ni and Mn in the spinel of the lithium positive electrode active material may be different from the bulk values that can be determined using ICP among others. Example C demonstrates that the Ni and Mn content in the spinel of the lithium positive electrode active material may be determined using three different methods based on electrochemistry, diffraction and electron microscopy, respectively.

The methods based on electrochemistry and diffraction exploit that variations in the Mn/Ni ratio change the ratio between Mn³⁺ and Mn⁴⁺. This is apparent by calculating the average oxidation state of Mn in LiₓNi_{y}Mn_{2-y}O₄ as (4*2−1*x−2*y)/(2−y) based on the assumption that the oxidation state of Li is 1+, Ni is 2+ and O is −2. Using this, the formula can be written as Li⁺¹Ni⁺²_{y}Mn⁺³_{1-2y}Mn⁺⁴_{1+y}O₄ in the case of x=1, and a similar expression for x different from 1.

Electrochemically, Mn³⁺ can be oxidized reversibly to Mn⁴⁺ and back by extraction and insertion of Li⁺ during cycling, and Ni²⁺ can be oxidized reversibly to Ni⁴⁺ and back by extraction and insertion of Li⁺ during cycling. It is thus possible to extract (and subsequently insert) two Li⁺ per Ni²⁺ and one Li⁺ per Mn³⁺. Based on the formula Li⁺¹Ni⁺²_{y}Mn⁺³_{1-2y}Mn⁺⁴_{1+y}O₄ in the case of x=1, the share of capacity related to Mn activity compared to the total capacity is thus given by (1−2y)/(1−2y+2y)=(1−2y). As an example y=0 corresponds to 0% capacity related to Mn activity and y=0.45 and 0.4 corresponds to 10% and 20% of the total capacity coming from Mn activity, respectively.

In LNMO, Mn³⁺/Mn⁴⁺ reactions are observed around 4 V vs. Li/Li⁺ and Ni²⁺/Ni⁴⁺ reactions are observed around 4.7 V vs. Li/Li⁺. It is therefore expected that the capacity measured between 3.5 V and 4.3 V vs. Li/Li⁺ compared to the total capacity between 3.5 V and 5 V vs. Li/Li⁺ corresponds to Mn activity. The capacity around 4V is determined using the third discharge at 29 mA/g (0.2 C) as described in Example A. During charge and discharge, the cell is not in equilibrium and the measured voltages may shift upwards during charge and downwards during discharge due to internal resistance in the cell. This effect is especially pronounced near sudden changes in cell voltage and the fraction of Mn-activity will therefore appear different depending on whether the analysis is based on a charge or a discharge. The true value will be between these two values and a reasonable estimate is the average between the two. FIG. 6a shows the discharge and charge voltage curves as a function of capacity for the third charge at 29 mA/g (0.2 C) as described in Example A. Using the capacities Q^{4V}_{cha} and Q^{4V}_{dis} corresponding to a voltage of 4.3 V during charge and discharge, respectively, and the total discharge capacity Q^{tot}_{dis}, the fraction of Mn-activity is given by (Q^{4V}_{cha}+(Q^{tot}_{dis}−Q^{4V}_{dis}))/(2*Q^{tot}_{dis}). This value is denoted “4V plateau”. The maximum and minimum values of the 4V plateau are given by (Q^{tot}_{dis}−Q^{4V}_{dis})/(Q^{tot}_{dis}) and (Q^{4V}_{cha})/(Q^{tot}_{dis}), respectively.

### Diffraction

The size of Mn³⁺ and Mn⁴⁺ ions are different and this affect the lattice parameter of the spinel. Powder x-ray diffraction data were collected on a Phillips PW1800 instrument system in θ-2θ geometry working in Bragg-Brentano mode using Cu Kα radiation (λ=1.541 Å). The observed data needs to be corrected for experimental parameters contributing to shifts in the observed peak positions, which are used to calculate the lattice parameter. This is achieved using the full profile fundamental parameter approach as implemented in the TOPAS software from Bruker. As a result the spinel lattice parameter is determined with an uncertainty around 5/10000 Å, which is enough to determine the amount of Mn³⁺ and thus the amount of Mn and Ni.

### Electron Microscopy

A direct measurement of the amount of Mn and Ni in the spinel is possible by elemental mapping using scanning transmission electron microscopy (STEM) in combination with energy dispersive x-ray spectroscopy (EDS). STEM-EDS has been used to measure the amount of Ni and Mn in three different samples, in order to compare the composition of the spinel phase with the values calculated from the 4V charge plateau in the electrochemical measurement.

STEM-EDS measurements were performed on a FEI Talos transmission electron microscope equipped with the ChemiSTEM EDS detector system. The microscope was operated in STEM mode with an acceleration voltage of 200 kV. Elemental maps were acquired and analyzed using the software Esprit 1.9 from Bruker. A standard-less quantification was performed using automatic background subtraction, series deconvolution and the Cliff-Lorimer method. Impurities or non-spinel phases in the sample were easily identified from a composition substantially different from the spinel, i.e. they are rich in either Mn or Ni, and the fact that they comprise a small fraction of the total sample. These non-spinel phases were not included in the quantification in order to strictly measure the composition of the spinel phase. The quantification provides atomic percentages of the elements present in the spinel phase. The amount of Ni in the spinel, Niy, was determined as Niy=2*Ni_{at %}/(Ni_{at %}+Mn_{at %}) where Ni_{at %} and Mn^{at %} are the atomic percentages of Ni and Mn measured in the spinel.

Three samples prepared with different values of Niy were analyzed as shown in Table 3 below and in FIG. 11. Ni net chemical composition refers to the overall Ni content in the sample and Niy refers to the Ni content of the spinel phase as measured using STEM-EDS and the 4V charge plateau. The table shows a good agreement between the two measurements of Niy, confirming that the 4V charge plateau is indeed directly related to the composition of the spinel phase. Furthermore, the data shows that Niy is not necessarily identical to the net chemical composition, but rather determined by the conditions during calcination.

TABLE 3

| Ni, net chemical | Niy | Niy | Niy |
|---|---|---|---|
| composition | STEM-EDS | 4 V charge plateau | X-ray diffraction |
| 0.46 | 0.461 | 0.458 | 0.458 |
| 0.5 | 0.450 | 0.444 | 0.446 |
| 0.46 | 0.474 | 0.473 | 0.477 |

As seen in FIG. 2a, a relation exists between the a-axis determined using XRD measurements and the ratio between Mn and Ni given by y as determined from the 4V plateau. The correspondence can be fitted with the line: a=−0.1932*y+8.2627. FIG. 2b shows the similar correspondence between the a-axis and the 4V plateau.

### Example D: Quantification of Ordering

Cation ordering of Ni and Mn in the spinel of the lithium positive electrode active material can be determined by Raman spectroscopy as described in Ionics (2006) 12, pp 117-126. To quantify the degree of ordering, it is used that the two peaks around 162 cm⁻¹ (151 cm⁻¹-172 cm⁻¹) and 395 cm⁻¹ (385 cm⁻¹-420 cm⁻¹) are related to cation ordering and the two peaks around 496 cm⁻¹ (482 cm⁻¹-505 cm⁻¹) and 636 cm⁻¹ (627 cm⁻¹-639 cm⁻¹) are not depending on ordering. In a simple approach, the area of each peak is calculated as indicated in FIG. 13, and the ordering parameter can be calculated as the ratio (A₁+A₂)/(A₃+A₄). This method compensates for variations in background and signal strength. A fully ordered spinel has a value around 0.4 and a fully disordered spinel has a value around 0.1.

Another method to determine the degree of ordering is to measure the difference dV between the two voltage plateaus at around 4.7 V during 29.6 mA/g (0.2 C) discharge.

This method requires sufficiently good materials and electrode fabrication in order to obtain flat and well separated plateaus as seen in FIGS. 6a and 6b. The difference is calculated as shown in FIG. 6b between the middle of each of the two plateaus around 4.7 V. The Q^{4V}_{dis} is determined as described in Example C and the middle of each of the two plateaus are determined at 25% of Q^{4V}_{dis} and 75% of Q^{4V}_{dis}. A fully ordered spinel has a value around 30 mV and a fully disordered spinel has a value around 60 mV.

FIG. 3 shows a comparison between the two ordering parameters that confirm a correlation. The correlation between dV and ordering is used in FIG. 4 to determine that cation ordering cause an increase in degradation.

1. A lithium positive electrode active material for a high voltage secondary battery, said lithium positive electrode active material comprising at least 94 wt % spinel, said spinel having a net chemical composition of LiₓNi_{y}Mn_{2-y}O₄, wherein:
0.95≤x≤1.05;
0.43≤y≤0.47; and
wherein said lithium positive electrode active material is made up of particles, said particles being characterized by one or more of the following parameter ranges: the particles have average aspect ratio below 1.6, the particles have a roughness below 1.35, particles have a circularity above 0.55.

2. The lithium positive electrode active material according to claim 1, where at least 90 wt % of said spinel is crystallized in disordered space group Fd-3m.

3. The lithium positive electrode active material according to claim 1, wherein said lithium positive electrode active material in a half-cell has a difference of at least 50 mV between the potentials at 25% and 75% of the capacity above 4.3 V during discharge with a current of around 29 mA/g.

4. The lithium positive electrode active material according claim 1, wherein said lithium positive electrode active material is calcined so that the lattice parameter a is between 8.171 and 8.183 Å.

5. The lithium positive electrode active material according to claim 4, wherein the lattice parameter a is between (−0.1932y+8.2613) Å and 8.183 Å.

6. The lithium positive electrode active material according to claim 4, wherein the lattice parameter a is between (−0.1932y+8.2613) Å and (−0.1932y+8.2667) Å.

7. The lithium positive electrode active material according to claim 4, wherein the lattice parameter a is between (−0.1932y+8.2613) Å and (−0.1932y+8.2641) Å.

8. The lithium positive electrode active material according to claim 1, wherein said lithium positive electrode active material has a tap density equal to or greater than 2.2 g/cm³.

9. The lithium positive electrode active material according to claim 1, wherein D50 of the particles of said lithium positive electrode active material satisfies: 3 μm<D50<12 μm.

10. The lithium positive electrode active material according to claim 1, wherein the BET area of said lithium positive electrode active material is below 1.5 m²/g.

11. The lithium positive electrode active material according to claim 1, wherein said particles are characterized by a solidity above 0.8.

12. The lithium positive electrode active material according to claim 1, wherein said particles are characterized by a porosity below 3%.

13. The lithium positive electrode active material according to claim 1, wherein 0.99≤x≤1.01.

14. The lithium positive electrode active material according to claim 1, wherein the capacity of said material in a half cell decreases by no more than 4% over 100 cycles between 3.5 to 5.0 V at 55° C.

15. The lithium positive electrode active material according to claim 1, wherein said lithium positive electrode active material has a capacity of at least 138 mAh/g.

16. The lithium positive electrode active material according to claim 1, wherein said lithium positive electrode active material is synthesized from a precursor containing Li, Ni, and Mn in a ratio Li:Ni:Mn: X:Y:2-Y, wherein: 0.95≤X≤1.05; and 0.42≤Y<0.5.

17. The lithium positive electrode active material according to claim 1, wherein y is determined by means of a method selected from the group consisting of electrochemical determination, X-ray diffraction and scanning transmission electron microscopy (STEM) in combination with energy dispersive X-ray spectroscopy (EDS).

18. The lithium positive electrode active material according to claim 1, wherein 0.43≤y<0.45.

19. A process for the preparation of a lithium positive electrode active material according to claim 1, said process comprising the steps of:
a. providing precursors for preparing said lithium positive electrode active material comprising at least 94 wt % spinel having a chemical composition of LiₓNi_{y}Mn_{2-y}O₄ wherein 0.95≤x≤1.05; and 0.43≤y≤0.47;
b. sintering the precursors of step a. by heating the precursors to a temperature of between 500° C. and 1200° C. to provide a sintered product,
c. cooling the sintered product of step b to room temperature.

20. The process according to claim 19, wherein part of step b is carried out in a reducing atmosphere.

21. The process according to claim 19, wherein said temperature of step b is between 850° C. and 1100° C.

22. The process according to claim 19, wherein during the cooling of step c, the temperature is maintained in an interval between 750° C. and 650° C. for a sufficient amount of time to obtain at least 94% phase purity of said lithium positive electrode active material.

23. The process according to claim 19, wherein at least one of the precursors is a precipitated compound.

24. The process according to claim 19, wherein the precipitated compound is a co-precipitated compound of Ni and Mn formed in a Ni—Mn co-precipitation step.

25. The process according to claim 24, wherein, said precursor in the form of a co-precipitated Ni—Mn has been prepared in a precipitation step, wherein a first solution of a Ni containing starting material, a second solution of a Mn containing starting material and a third solution of a precipitating anion are added simultaneously to a liquid reaction medium in a reactor in such amounts that in relation to the added Ni, each of Mn and the precipitating anion are added in a ratio of from 1:10 to 10:1, relative to the stoichiometric amounts of the precipitate.

26. The process according to claim 25, wherein the first, second and third solutions are added to the reaction medium amounts calibrated so as to maintain the pH of the reaction mixture at alkaline pH of between 8.0 and 10.0.

27. The process of any of claim 25, wherein said first, second and third solutions are added to the reaction mixture over a prolonged period of between 2.0 and 11 hours.

28. The process of claim 25, wherein said first, second and third solutions are added to the reaction mixture under vigorous stirring providing a power input of from 2 W/L to 25 W/L.

29. A secondary battery comprising the lithium positive electrode active material according to claim 1.

30. Use of the lithium positive electrode active material according to claim 1 for reducing the degradation of the material during storage and use.
